(19) United States
(12) Patent Application Publication
(10) Pub. No.: US 2010/0154239 A1
(43) Pub. Date: Jun. 24, 2010

(54) DRYING APPARATUS

(75) Inventor: Peter Nigel Hutchinson, Malmesbury (GB)

Correspondence Address: MORRISON & FOERSTER LLP, 1650 TYSONS BOULEVARD, SUITE 400, MCLEAN, VA, 22102, US

(73) Assignee: DYSON TECHNOLOGY LIMITED, Wiltshire (GB)

(21) Appl. No.: 12/160,961

(22) PCT Filed: Jan. 16, 2007
(86) PCT No.: PCT/GB2007/000106

§ 371 Date: Aug. 8, 2008

(30) Foreign Application Priority Data
Jan. 17, 2006 (GB) 0600869.2

(51) Int. Cl. F26B 21/06

(52) U.S. Cl. 34/82

(57) ABSTRACT

A drying apparatus such as a hand dryer has a casing, a fan located within the casing and capable of creating an airflow, and an inlet arranged in the casing through which air is drawn into the apparatus by the fan. At least one outlet opening communicates with the fan and is arranged in the casing so as to direct an airflow towards an object to be dried. The inlet comprises at least one inlet opening and a corresponding shield member which is spaced apart from and overlies the inlet opening such that air drawn into the apparatus by the fan passes through the inlet opening and is then deflected around the shield member. This allows air to be drawn freely into the casing while preventing objects which might cause damage to a filter or the fan or motor from being inserted into the casing via the inlet.

### REFERENCE TO RELATED APPLICATIONS

This application is a national stage application under 35 USC 371 of International Application No. PCT/GB07/000106, filed Jan. 16, 2007, which claims the priority of United Kingdom Application No. 0600869.2, filed Jan. 17, 2006, the contents of both of which prior applications are incorporated herein by reference.

### FIELD OF THE INVENTION

The invention relates to drying apparatus. Particularly, but not exclusively, the invention relates to a hand dryer in which air is drawn into a casing via an inlet and emitted through at least one opening in the casing.

### BACKGROUND OF THE INVENTION

It is known to provide a filter immediately downstream of the inlet to remove any debris which may be drawn into the drying apparatus via the inlet. It is also known to provide a simple passageway leading from the inlet to the motor and fan unit which draws the airflow into the casing. One of the problems of the prior art is that the filter, or the motor and fan unit, can be accessible from outside the casing and so can be vulnerable to damage.

### SUMMARY OF THE INVENTION

It is an object of the invention to provide drying apparatus which is less prone to damage than prior art apparatus.

The invention provides drying apparatus having a casing, a fan located within the casing and capable of creating an airflow, an inlet arranged in the casing through which air is drawn into the apparatus by the fan, and at least one outlet opening communicating with the fan and arranged in the casing so as to direct an airflow towards an object to be dried, wherein the inlet comprises at least one inlet opening and a corresponding shield member which is spaced apart from and overlies the inlet opening such that air drawn into the apparatus by the fan passes through the inlet opening and is then deflected around the shield member.

The provision of a shield member which is spaced apart from but overlies the inlet opening allows air to be drawn freely into the casing whilst preventing objects which might cause damage to a filter or the fan or motor from being inserted into the casing via the inlet. The shield member also provides some protection against fire damage in the event of a flame being placed beneath the drying apparatus.

Preferably, the shield member has substantially the same shape as the inlet opening and, more preferably, the shield member overlaps at least a part of the periphery of the inlet opening. This arrangement prevents there being a direct line of access to the filter, fan or motor via the inlet which reduces the risk of deliberate damage being inflicted on these components.

Preferably, the shield member carries a vane which projects towards, and more preferably terminates in, the plane of the inlet opening. The provision of the vane helps to divert the incoming airflow more smoothly around the shield member and improves the efficiency of the apparatus.

In a preferred embodiment, the inlet comprises a plurality of inlet openings, the preferred number of openings being between three and six. This allows the size of each inlet opening to be kept relatively small whilst permitting a suitable flow of air to enter the casing via the inlet.

### BRIEF DESCRIPTION OF THE DRAWINGS

An embodiment of the invention in the form of a hand dryer will now be described with reference to the accompanying drawings, in which:

FIG. 1 is a side view of a hand dryer according to the invention;

FIG. 2 is a perspective view from above of the hand dryer of FIG. 1;

FIG. 3 is a side sectional view of the hand dryer of FIG. 1;

FIG. 4 is a side sectional view, shown on an enlarged scale, of the upper ends of the air ducts forming part of the hand dryer of FIG. 1;

FIG. 5 is a perspective view from below of the hand dryer of FIG. 1;

FIG. 6 is an underneath view of the hand dryer of FIG. 1; and

FIG. 7 is a section taken on line VII-VII of FIG. 6.

### DETAILED DESCRIPTION OF THE INVENTION

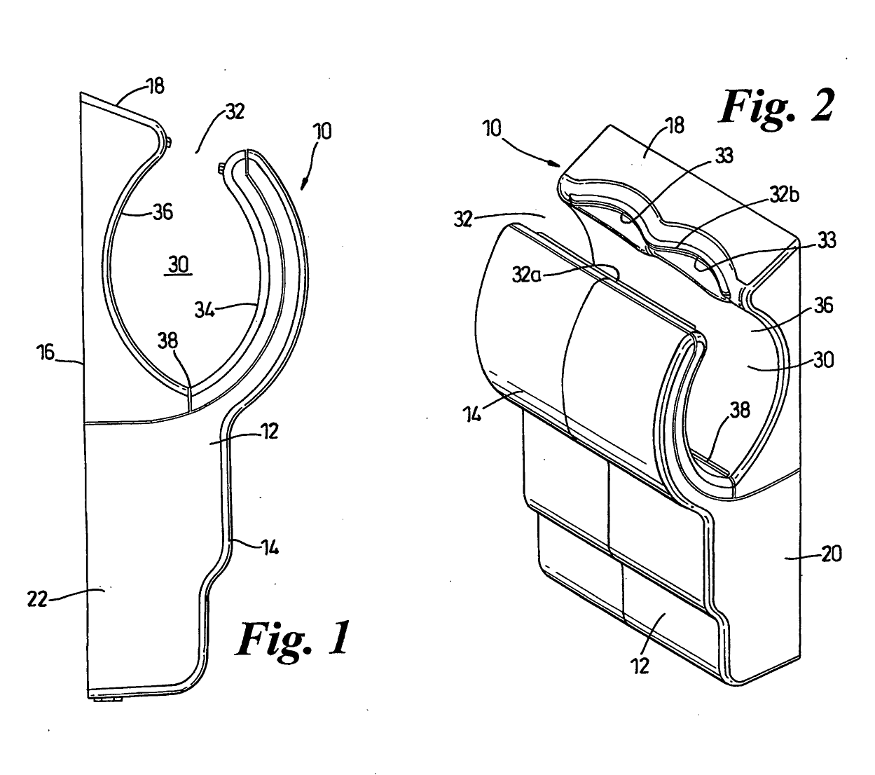

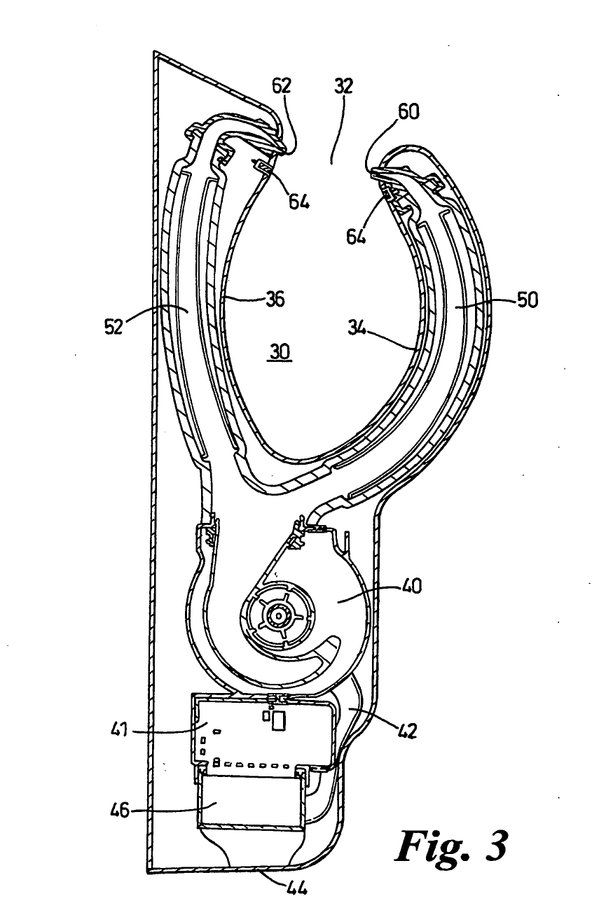

Referring firstly to FIGS. 1 and 2, the hand dryer 10 shown in the drawings comprises an outer casing 12 having a front wall 14, a rear wall 16, an upper face 18, a lower face 19 and side walls 20, 22. The rear wall 16 can incorporate fixing devices (not shown) for securing the hand dryer 10 to a wall or other structure prior to use. An electrical connection (not shown) is also provided on the rear wall or elsewhere on the casing 12. A cavity 30 is formed in the upper part of the casing 12 as can be seen from FIGS. 1 and 2. The cavity 30 is open at its upper end and delimited thereat by the top of the front wall 14 and the front of the upper face 18. The space between the top of the front wall 14 and the front of the upper face 18 forms a cavity entrance 32 which is sufficiently wide to allow a user's hands to be introduced to the cavity 30 through the cavity entrance 32. The cavity 30 is also open to the sides of the hand dryer 10 by appropriate shaping of the side walls 20, 22.

The cavity 30 has a front wall 34 and a rear wall 36 which delimit the cavity 30 to the front and rear respectively. Located in the lowermost end of the cavity 30 is a drain 38 which communicates with a reservoir (not shown) located in the lower part of the casing 12. The purpose of the drain and reservoir will be described below.

As shown in FIG. 3, a motor (not shown) is located inside the casing 12 and a fan 40, which is driven by the motor, is also located inside the casing 12. The motor is connected to the electrical connection and is controlled by a controller 41. The inlet 42 of the fan 40 communicates with an air inlet 44 formed in the casing 12. The inlet 44 will be described in more detail below. A filter 46 is located in the air passageway connecting the air inlet 44 to the fan inlet 42 so as to prevent the ingress of any debris which might cause damage to the motor or the fan 40. The outlet of the fan 40 communicates with a pair of air ducts 50, 52 which are located inside the casing 12. The front air duct 50 is located primarily between the front wall 14 of the casing 12 and the front wall 34 of the cavity 30, and the rear air duct 52 is located primarily between the rear wall 16 of the casing 12 and the rear wall 36 of the cavity 30.

The air ducts 50, 52 are arranged to conduct air from the fan 40 to a pair of opposed slot-like openings 60, 62 which are located in the front and rear walls 34, 36 respectively of the cavity 30. The slot-like openings 60, 62 are arranged at the upper end of the cavity 30 in the vicinity of the cavity entrance 32. The slot-like openings 60, 62 are each configured so as to direct an airflow generally across the cavity entrance 32 towards the opposite wall of the cavity 30. The slot-like openings 60, 62 are offset in the vertical direction and angled towards the lowermost end of the cavity 30.

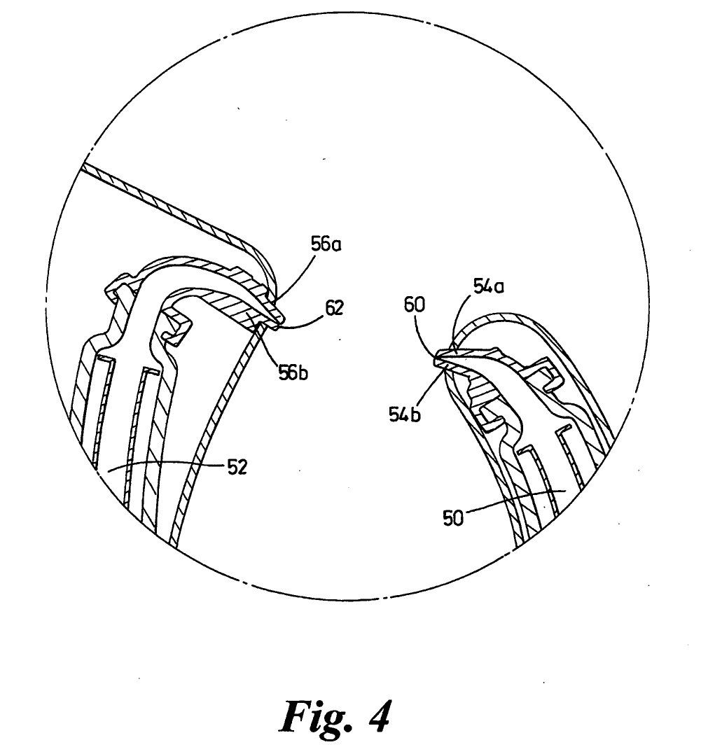

FIG. 4 shows the upper ends of the air ducts 50, 52 and the slot-like openings 60, 62 in greater detail. As can be seen, the walls 54a, 54b of the air duct 50 converge to form the slot-like opening 60 and the walls 56a, 56b of the air duct 52 converge to form the slot-like opening 62. In this embodiment, the slot-like opening 60 has a constant width of 0.3 mm and the slot-like opening 62 has a constant width of 0.4 mm. It is possible to arrange for one or both of the slot-like openings 60, 62 to have a non-constant width; for example, the width of the slot-like opening 62 may increase towards the centre of the apparatus to a width of approximately 0.7 mm.

Sensors 64 are positioned in the front and rear walls 34, 36 of the cavity 30 immediately below the slot-like openings 60, 62. These sensors 64 detect the presence of a user's hands which are inserted into the cavity 30 via the cavity entrance 32 and are arranged to send a signal to the motor when a user's hands are introduced to the cavity 30. As can be seen from FIGS. 1 and 3, the walls 54a, 54b, 56a, 56b of the ducts 50, 52 project slightly beyond the surface of the front and rear walls 34, 36 of the cavity 30. The inward projection of the walls 54a, 54b, 56a, 56b of the ducts 50, 52 reduces the tendency of the user's hands to be sucked towards one or other of the walls 34, 36 of the cavity, which enhances the ease with which the hand dryer 10 can be used. The positioning of the sensors 64 immediately below the inwardly projecting walls 54a, 54b, 56a, 56b of the ducts 50, 52 also reduces the risk of the sensors 64 becoming dirty and inoperative.

As can be seen from FIG. 2, the shape of the cavity entrance 32 is such that the front edge 32a is generally straight and extends laterally across the width of the hand dryer 10. However, the rear edge 32b has a shape which consists of two curved portions 33 which generally follow the shape of the backs of a pair of human hands as they are inserted downwardly into the cavity 30 through the cavity entrance 32. The rear edge 32b of the cavity entrance 32 is substantially symmetrical about the centre line of the hand dryer 10. The intention of the shaping and dimensioning of the front and rear edges 32a, 32b of the cavity entrance 32 is that, when a user's hands are inserted into the cavity 30 through the cavity entrance 32, the distance from any point on the user's hands to the nearest slot-like opening is substantially uniform.

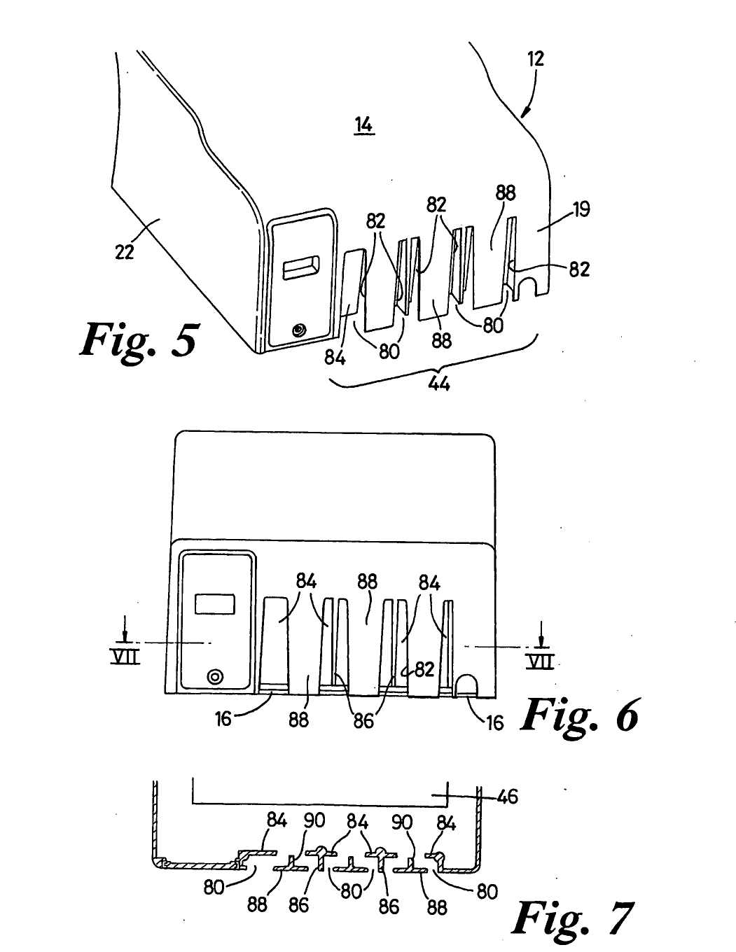

FIGS. 5 to 7 show the inlet 44 of the hand dryer 10 in greater detail. The inlet 44 is provided in the lower face 19 of the casing 12. The lower face 19 is downward-facing and so, in use, the inlet 44 faces the floor of a room in which the hand dryer is to be used. The inlet 44 comprises a plurality of inlet openings 80. In this embodiment, four inlet openings 44 are provided. However, the number of inlet openings could be varied and it is envisaged that between three and six inlet openings will normally provide sufficient airflow whilst maintaining the structural integrity of the casing 12.

Each inlet opening 80 has a generally trapezoidal shape and is formed integrally with the casing 12 during manufacture. In the complete apparatus, each inlet opening 80 is closed at the rear side by the rear wall 16 of the casing 12 and extends toward the front wall 14 thereof. Each inlet opening 80 has a periphery 82 delimiting the opening 80. A shield member 84 is provided adjacent each inlet opening 80. Each shield member 84 is formed as a generally flat plate of generally trapezoidal shape similar to that of the corresponding inlet opening 80 and extends across the respective inlet opening 80 so as to overlie the opening 80 on the internal side thereof. The sides of the shield member 84 overlap the opposing long sides of the periphery 82 as can be seen from FIGS. 6 and 7. In this way, there is no direct line of sight from any point outside the casing 12 to the filter 46.

Each shield member 84 approaches the periphery 82 of the respective inlet opening 80 at the end thereof remote from the rear wall 16. That part of the periphery 82 is therefore formed by one edge of the shield member 84. A gap is formed between the shield member 84 and the periphery of the inlet opening 80, the size of which gap increases towards the rear wall 16.

A vane 86 is carried by each of two of the four shield members 84 shown in FIGS. 5 to 7. The vane 86 is essentially planar and projects from the respective shield member 84 towards the lower face 19 of the casing 12. The vane 86 is positioned centrally of the shield member 84 so that the vane 86 lies substantially midway between the opposing long sides of the periphery 82 of the inlet opening 80. The vane 86 terminates in the plane of the inlet openings 80 (which is also the plane of the lower face 19 of the casing 12). Viewed from the side, the vanes 86 will have a generally triangular shape. Each vane 86 divides the space between the respective inlet opening 80 and the associated shield member 84 into two generally equal halves.

A portion 88 of the lower face 19 of the casing 12 lies between each pair of adjacent inlet openings 80. A vane 90, similar to the vanes 86, is carried by each of the casing portions 88. Each vane 90 is substantially planar and extends towards the plane in which the shield members 84 lie. As before, each vane 90 terminates in the plane of the shield members and lies substantially midway between the edges of the shield members which lie closest to the vane 90.

The features of the inlet 44 described above are intended to be formed as a single unit with the shield members 84, vanes 86 and vanes 90 being manufactured integrally with the front wall 14, side walls 20, 22 and lower face 19 of the casing 12. As can be seen from FIG. 7, the shield members 84 which are associated with the outermost inlet openings 80 can be supported by the outermost portions of the lower face 19 of the casing 12.

In the embodiment shown, four inlet openings 80 are provided. The innermost inlet openings have the same shape and configuration as one another whilst the outermost inlet openings differ therefrom. The inlet opening on the left hand side as shown in the drawings is similar to the innermost inlet openings, save that the corresponding shield member is supported along one of the long sides of the periphery and that no vane is provided on the shield member. The inlet opening on the right hand side as shown is similar to the left-hand inlet opening but is significantly narrower.

As can be seen from FIG. 7, the arrangement described provides an inlet 44 which forces the incoming air to follow a convoluted path as it enters the drying apparatus 10. The shape of the path defined between the vanes and the shield members includes two right-angled bends so that the air drawn into the dryer by the fan 40 is required to follow a “dog-leg” type path. There is thus no direct line of sight allowed from the outside of the casing 12 to any part of the interior of the casing 12 in which the filter, fan or motor might be housed.

The hand dryer 10 described above operates in the following manner. When a user's hands are first inserted into the cavity 30 through the cavity entrance 32, the sensors 64 detect the presence of the user's hands and send a signal to the motor to drive the fan 40. The fan 40 is thus activated and air is drawn into the hand dryer 10 via the air inlet 44 at a rate of approximately 20 to 40 litres per second and preferably 25 to 27 litres per second, more preferably air is drawn into the hand dryer 10 at a rate of 31 to 35 litres per second. The incoming air passes through the inlet openings 80 between the vanes 86 and is deflected around the shield members before being passed to the filter 46.

The air passes through the filter 46 and along the fan inlet 42 to the fan 40. The airflow leaving the fan 40 is divided into two separate airflows; one passing along the front air duct 50 to the slot-like opening 60 and the other passing along the rear air duct 52 to the slot-like opening 62.

The airflow is ejected from the slot-like openings 60, 62 in the form of very thin, stratified sheets of high velocity, high pressure air. As the airflows leave the slot-like openings 60, 62, the air pressure is at least 15 kPa and preferably approximately 20 to 23 kPa. Furthermore, the speed of the airflow leaving the slot-like openings 60, 62 is at least 80 m/s and preferably at least 100 and 150 m/s, more preferably approximately 180 m/s. Because the size of the slot-like opening 62 located at the end of the rear duct 52 is greater than the size of the slot-like opening 60 located at the end of the front duct 50, a larger volume of air is emitted from the duct 52 than from the duct 50. This provides a greater mass of air for drying the backs of the user's hands which is advantageous.

The two thin sheets of stratified, high velocity, high pressure air are directed towards the surfaces of the user's hands which, during use, are inserted fully into the cavity 30 and are subsequently withdrawn from the cavity 30 via the cavity entrance 32. As the user's hands pass into and out of the cavity 30, the sheets of air blow any existing water off the user's hands. This is achieved reliably and effectively because of the high momentum of the air leaving the slot-like openings 60, 62 and because the airflow is evenly distributed along the length of each slot-like opening 60, 62.

Each stratified sheet of air is directed towards the wall of the cavity 30 which is remote from the slot-like opening through which the respective sheet of air is emitted. Because the slot-like openings 60, 62 are also inclined towards the lowermost end of the cavity 30, the emitted airflows are directed into the cavity 30. This reduces the risk of turbulent air movement being felt by the user outside the casing, eg in the user's face.

It is envisaged that it will take only a small number of “passes” of the hand dryer described above to dry a user's hands to a satisfactory degree. (By “pass”, we mean a single insertion of the hands into the cavity and subsequent removal therefrom at a speed which is not unacceptable to an average user. We envisage that a single pass will have a duration of no more than 3 seconds.) The momentum achieved by the airflows is sufficient to remove the majority of water found on the surface of the user's hands after washing during a single pass.

The water removed by the airflows is collected inside the cavity 30. Each airflow will rapidly lose its momentum once it has passed the user's hands and the water droplets will fall to the lower end of the cavity 30 under the forces of gravity whilst the air exits the cavity 30 either through the cavity entrance 32 or via the open sides of the cavity 30. The water, however, is collected by the drain 38 and passed to a reservoir (not shown) where it is collected for disposal. The reservoir can be emptied manually if desired. Alternatively, the hand dryer 10 can incorporate some form of water dispersal system including, for example, a heater for evaporating the collected water into the atmosphere. The means by which the collected water is dispersed does not form part of the present invention.

In an alternative embodiment, the slot-like openings 60a, 62a can be arranged so that the sheets of air which are emitted therefrom are directed generally along planes which are substantially parallel to one another. This minimises the amount of turbulent flow present inside the cavity 30 whilst the drying apparatus is in use.

The invention is not intended to be limited to the precise detail of the embodiment described above. Modifications and variations to the detail which do not alter the scope of the invention will be apparent to a skilled reader. For example, the shape of the inlet openings and the shield members can be varied without departing from the essence of the present invention.

1. A drying apparatus comprising a casing, a fan located within the casing and capable of creating an airflow, an inlet arranged in the casing through which air is drawn into the apparatus by the fan, and at least one outlet opening communicating with the fan and arranged in the casing so as to direct an airflow towards an object to be dried,
wherein the inlet comprises at least one inlet opening and a corresponding shield member which is spaced apart from and overlies the inlet opening such that air drawn into the apparatus by the fan passes through the inlet opening and is then deflected around the shield member.

2. The drying apparatus of claim 1, wherein the shield member has a shape which is substantially the same as that of the inlet opening.

3. The drying apparatus of claim 1, wherein the shield member overlaps at least a part of a periphery of the inlet opening.

4. The drying apparatus of claim 3, wherein the shield member overlaps the periphery of the inlet opening on two opposing sides thereof.

5. The drying apparatus of claim 1, wherein the shield member approaches the periphery of the inlet opening towards a first end thereof.

6. The drying apparatus of claim 5, wherein the shield member meets the periphery of the inlet opening at the first end.

7. The drying apparatus of claim 1, wherein the shield member carries a vane which projects toward the inlet opening.

8. The drying apparatus of claim 7, wherein the vane terminates in the plane of the inlet opening.

9. The drying apparatus of claim 1, wherein the inlet comprises a plurality of inlet openings.

10. The drying apparatus of claim 9, wherein the number of inlet openings is between three and six.

11. The drying apparatus of claim 9, wherein the size of one of the inlet opening is the same as at least one of the other inlet openings.

12. The drying apparatus of claim 9, wherein between each pair of adjacent inlet openings, the casing carries a vane projecting towards the shield members.

13. The drying apparatus of claim 1, wherein a filter is located in the casing between the inlet and the fan.

14. The drying apparatus of claim 1, wherein the inlet is located in a downward-facing surface of the casing.

15. The drying apparatus of claim 1, wherein the drying apparatus is a hand dryer.
